(19) United States
(12) Patent Application Publication
(10) Pub. No.: US 2026/0300373 A1
(43) Pub. Date: Oct. 1, 2026

(54) ADAPTATION OF LANGUAGE MODEL RESPONSE STYLE

(71) Applicant: International Business Machines Corporation, Armonk, NY (US)

(72) Inventor: Bo WEN, Chappaqua, NY (US)

(21) Appl. No.: 19/094,605

(22) Filed: Mar. 28, 2025

(51) Int. Cl. G06F 16/383; G06F 16/334; G06F 40/35

(52) U.S. Cl. CPC G06F 16/383; G06F 16/3347; G06F 40/35

(57) ABSTRACT

In some implementations, a computer system may receive user input in a conversational context. The computer system may search a vector database for relevant example conversations between experts and users based on semantic similarity between the user input and indexed user utterances in the vector database. The computer system may retrieve a set of relevant example conversations from the vector database based on the searching. The computer system may adapt a response style of a response to the user input based on the set of relevant example conversations and using a large language model. The computer system may output the response.

### BACKGROUND

This disclosure generally relates to conversational artificial intelligence, and more specifically, to adaptation of a language model.

### SUMMARY

Some aspects described herein relate to a method. The method may include receiving user input in a conversational context. The method may include searching a vector database for relevant example conversations between experts and users based on semantic similarity between the user input and indexed user utterances in the vector database. The method may include retrieving a set of relevant example conversations from the vector database based on the searching. The method may include adapting a response style of a response to the user input based on the set of relevant example conversations and using a large language model (LLM). The method may include outputting the response.

Some aspects described herein relate to a computer system. The computer system may include a processor set, one or more computer-readable storage media, and program instructions stored on the one or more computer-readable storage media to cause the processor set to perform operations. The operations may include storing a set of example conversations between experts and users in a vector database. The operations may include indexing each user utterance in the vector database based on semantic similarity to expert responses. The operations may include retrieving a set of relevant example conversations from the vector database based on semantic similarity between a user input in a conversational context and the indexed user utterances. The operations may include adapting a response style of a chatbot based on the set of relevant example conversations. The operations may include outputting, using an LLM of the chatbot, a response to the user input that follows the adapted response style.

Some aspects described herein relate to a computer program product. The computer program product may include one or more computer-readable storage media and program instructions stored on the one or more computer-readable storage media to perform operations. The operations may include generating a response style of a chatbot for responses to user inputs to a chatbot. The operations may include receiving a user input. The operations may include retrieving, from a vector database of example conversations associated with the chatbot, a set of relevant example conversations based on the user input and a conversational context of the user input. The operations may include adapting, via in-context few-shot learning, the response style of the chatbot based on the set of relevant example conversations. The operations may include outputting a response to the user input using an LLM, where the response follows the adapted response style.

### BRIEF DESCRIPTION OF THE DRAWINGS

FIG. 1 is a diagram of an example computing environment for adapting a response style of a conversation using a large language model.

FIG. 2 is a diagram of an example implementation associated with generating responses to user input using a response style.

FIG. 3 is a diagram of an example implementation associated with using a response style for a response to user input.

FIG. 4 is a diagram of an example implementation associated with providing chatbot responses to user inputs using a response style.

FIG. 5 is a flowchart of an example process associated with adaptation of a language model response style.

FIG. 6 is a flowchart of an example process associated with adaptation of a language model response style.

FIG. 7 is a flowchart of an example process associated with adaptation of a language model response style.

### DETAILED DESCRIPTION

The following detailed description of example implementations refers to the accompanying drawings. The same reference numbers in different drawings may identify the same or similar elements.

According to an aspect, a method may include receiving user input in a conversational context. The method may include searching a vector database for relevant example conversations between experts and users based on semantic similarity between the user input and indexed user utterances in the vector database. The method may include retrieving a set of relevant example conversations from the vector database based on the searching. The method may include adapting a response style of a response to the user input based on the set of relevant example conversations and using a large language model (LLM). The method may include outputting the response. By searching for relevant example conversations in a vector database, the method can provide more accurate and contextually relevant responses to user input, leading to a better user experience. The use of semantic similarity between the user input and indexed user utterances in the vector database enables the method to capture nuances in language and understand the conversational context more effectively. In this way, the use of a response style that better matches the user input can lead to a quicker understanding and thus fewer iterations of query and response, thereby reducing the computational resources.

In one or more embodiments, the set of relevant example conversations are associated with a domain or task involving psychotherapy, medical consulting, financial consulting, legal consulting, or business consulting. By using relevant conversations of professionals interacting with users, the user may receive responses that are more likely to be understood by the user, resulting in fewer iterations for clarification and explanation. As a result, processing resources are conserved.

In one or more embodiments, the vector database is a Milvus® database or Redis® database.

In one or more embodiments, the device includes fine-tuning the LLM independent of updating the vector database. In this way, the training is reduced as the training can be performed for either the LLM or the vector database rather than both. As a result, processing resources are conserved.

In one or more embodiments, the method includes performing in-context few-shot learning at an inference stage of the conversation context. In-context learning reduces the processing resources necessary for training.

In one or more embodiments, the retrieving of the set of relevant example conversations comprises retrieving the set of relevant example conversations based on a combination of the user input, the conversational context, and a set of predefined criteria. This can help to reduce the processing resources for the retrieving.

In one or more embodiments, the set of predefined criteria comprises a number of turns in a conversation or a presence of a set of specific keywords. This helps to improve the retrieving, which conserves processing resources.

In one or more embodiments, the method includes generating the conversational context based on a set of predefined formulas associated with efficient retrieval of example conversations. This helps to focus the responses and thus reduce the iterations, which conserves processing resources.

In one or more embodiments, the adapted response style is associated with a cognitive behavioral therapist.

In one or more embodiments, the method includes performing in-context few-shot learning of the LLM by providing the set of relevant example conversations to the LLM as a prompt, without modifying the LLM or using additional training data. This reduces the processing resources used for training.

According to an aspect, a computer system may include a processor set, one or more computer-readable storage media, and program instructions stored on the one or more computer-readable storage media to cause the processor set to perform operations. The operations may include storing a set of example conversations between experts and users in a vector database.

The operations may include indexing each user utterance in the vector database based on semantic similarity to expert responses. The operations may include retrieving a set of relevant example conversations from the vector database based on semantic similarity between a user input in a conversational context and the indexed user utterances. The operations may include adapting a response style of a chatbot based on the set of relevant example conversations. The operations may include outputting, using an LLM of the chatbot, a response to the user input that follows the adapted response style. By retrieving relevant example conversations in a vector database, the method can provide more accurate and contextually relevant responses to user input, leading to a better user experience. The use of semantic similarity between the user input and indexed user utterances in the vector database enables the method to capture nuances in language and understand the conversational context more effectively. In this way, the use of a response style that better matches the user input can lead to a quicker understanding and thus fewer iterations of query and response, thereby reducing the computational resources.

In one or more embodiments, the LLM capable of in-context learning. This reduces the processing resources used for training.

In one or more embodiments, the retrieving of the set of relevant example conversations comprises retrieving the set of relevant example conversations based on a combination of the user input, the conversational context, and a set of predefined criteria. This can help to reduce the processing resources for the retrieving.

In one or more embodiments, the adapting of the response style comprises adapting the response style using few-shot learning with the set of relevant example conversations. This can help to reduce the processing resources for the retrieving.

In one or more embodiments, the operations further comprise: decoupling the vector database and the LLM, where the vector database and the LLM are updated independently of each other and conversation protocols are decoupled from the LLM. In this way, the updating or retraining is reduced as the training can be performed for either the LLM or the vector database rather than both. As a result, processing resources are conserved.

According to an aspect, a computer program product may include one or more computer-readable storage media and program instructions stored on the one or more computer-readable storage media to perform operations. The operations may include generating a response style of a chatbot for responses to user inputs to a chatbot. The operations may include receiving a user input. The operations may include retrieving, from a vector database of example conversations associated with the chatbot, a set of relevant example conversations based on the user input and a conversational context of the user input. The operations may include adapting, via in-context few-shot learning, the response style of the chatbot based on the set of relevant example conversations. The operations may include outputting a response to the user input using an LLM, where the response follows the adapted response style. By adapting a response style to better match the user input, the user may have a quicker understanding of the responses and thus require fewer iterations of query and response, thereby reducing the computational resources.

In one or more embodiments, the operations further comprise: performing the in-context few-shot learning at an inference stage, without additional training or fine-tuning of the LLM. This reduces the processing resources used for training.

In one or more embodiments, the operations further comprise: updating the vector database independently of the LLM. This reduces the processing resources used for training as both do not need to be updated or trained.

In one or more embodiments, the operations further comprise: using the in-context few-shot learning to decouple conversation skills of the vector database from the LLM. This reduces the processing resources used for training.

In one or more embodiments, the operations further comprise: further adapting the response style iteratively based on subsequent user inputs, user behavior, and the conversational context. Improvements to the response style can improve understanding and reduce iterations, which reduces processing resources.

Conversational artificial intelligence (AI) systems, such as chatbots, often struggle to maintain consistent and engaging interactions with users, particularly when dealing with complex conversation scenarios or domain-specific knowledge. One major challenge is the conventional method of injecting expert knowledge into LLMs through fine-tuning, which can be costly, time-consuming, and tightly couples the conversation skills with the specific LLM architecture. Furthermore, the probabilistic nature of transformer architecture in LLMs makes it difficult to guarantee consistent performance during the inference stage (runtime).

In addition, traditional approaches to conversational AI rely on either rule-based systems, which can be inflexible and limited in their ability to handle complex conversations, or generative models, which can struggle to produce coherent and relevant responses. The use of in-context learning, which allows LLMs to learn from a few examples in the prompt, has shown promise, but it is limited by the context window size and can be brittle to changes in the conversation scenario.

Another significant challenge in conversational AI is the difficulty in decoupling the conversation protocol from the underlying language model. If the LLM is tightly coupled to the knowledge based, it challenging to update or change the conversation protocol without retraining the language model, which can be time-consuming and expensive. Moreover, traditional conversational AI systems often rely on knowledge-retrieval-based approaches, which can result in responses that feel more like manual or document-based answers rather than engaging and empathetic conversations. The lack of ability to incorporate experiential data and the conversation style of domain experts into conversational AI systems further exacerbates this issue.

Some implementations described herein provide a method, implemented by a computer system, for controlling a chatbot's response style through few-shot learning. For example, the method may receive user input in a conversational context, search a vector database for relevant example conversations between experts and users based on semantic similarity between the user input and indexed user utterances, and retrieve a set of relevant example conversations. The method may then adapt a response style of a response to the user input based on the set of relevant example conversations and using an LLM, and output the response. In some aspects, the set of relevant example conversations may be associated with a domain or task involving psychotherapy, and the vector database may be implemented using a system such as a Milvus database or a Redis database.

In this way, the method reduces the computational overhead of fine-tuning or retraining the LLM, conserving processing resources, memory resources, and network resources. The method enables the language model to utilize thousands of different examples via in-context learning at runtime without requiring fine-tuning. Additionally, the decoupling of the conversation protocol from the underlying language model enables modular updates and maintenance of the chatbot's knowledge and behavior, resulting in a more efficient use of system resources. The method may also conserve computing resources, networking resources, and/or other resources that would have otherwise been consumed by failing to quickly and effectively respond to user input. By leveraging pre-existing expert knowledge through a vector database, the method further conserves the computing resources required for generating expert-level responses.

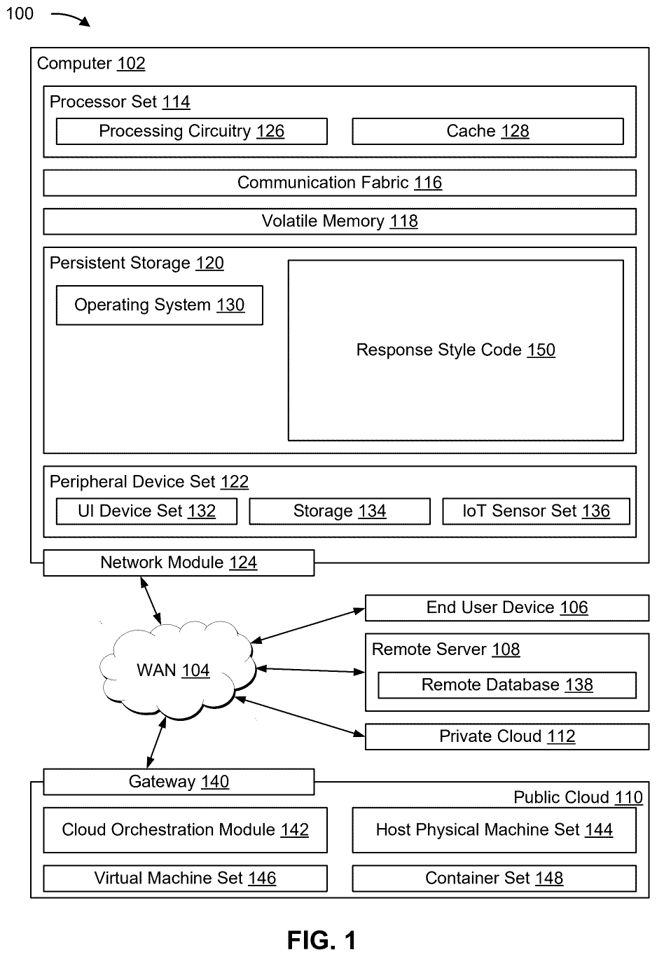

FIG. 1 is a diagram of an example computing environment 100 for adapting a response style of a conversation using an LLM as described herein.

Computing environment 100 contains an example of an environment for the execution of at least some of the computer code involved in performing the inventive methods, such as response style code 150. In addition to response style code 150, computing environment 100 includes, for example, computer 102, wide area network (WAN) 104, end user device (EUD) 106, remote server 108, public cloud 110, and private cloud 112. In this embodiment, computer 102 includes processor set 114 (including processing circuitry 126 and cache 128), communication fabric 116, volatile memory 118, persistent storage 120 (including operating system 130 and response style code 150, as identified above), peripheral device set 122 (including user interface (UI) device set 132, storage 134, and Internet of Things (IOT) sensor set 136), and network module 124. Remote server 108 includes remote database 138. Public cloud 110 includes gateway 140, cloud orchestration module 142, host physical machine set 144, virtual machine set 146, and container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one or more computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114.

Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in response style code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

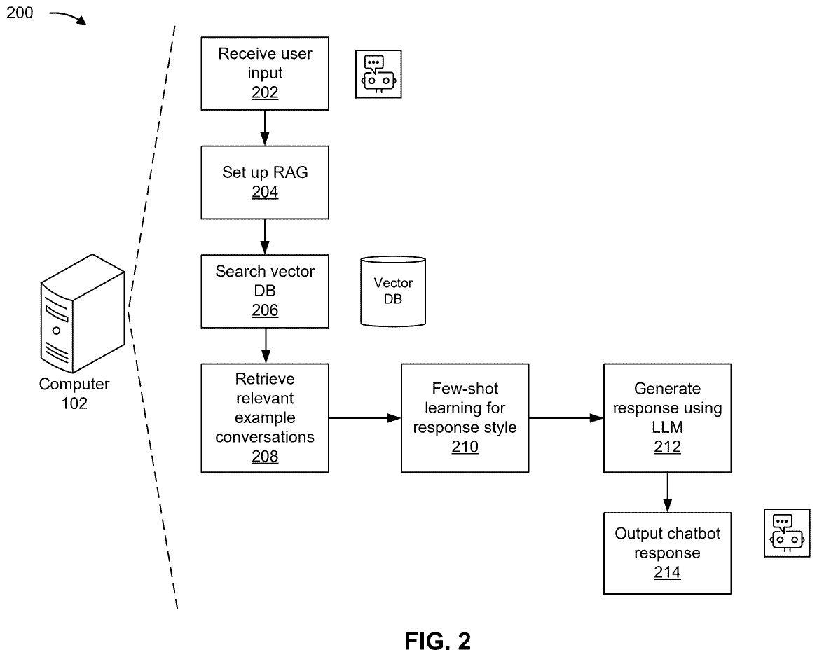

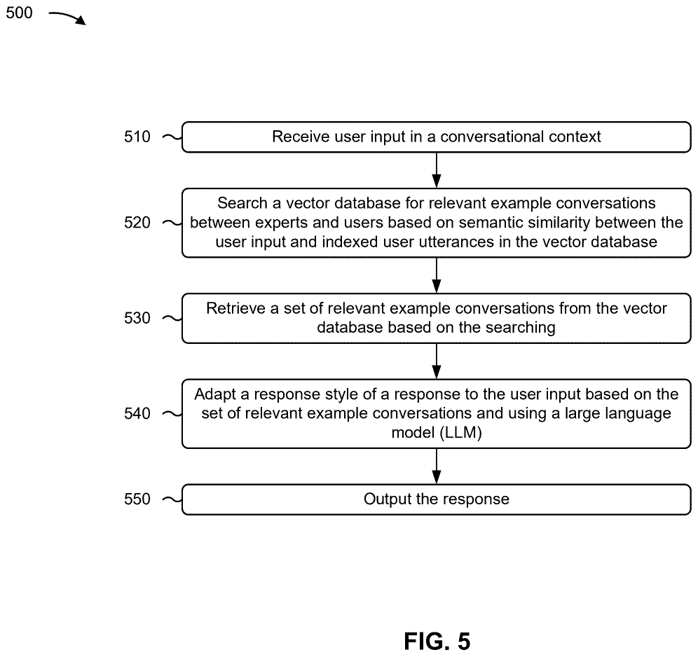

The code included in the response style code 150 typically includes at least some of the computer code involved in performing one or more operations described herein, such as the operations of the implementations in FIGS. 2-4 and the processes described in FIGS. 5-7.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

EUD 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of VCEs will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some implementations, a device (e.g., computer 102, computer system) may receive user input in a conversational context. The device may search a vector database for relevant example conversations between experts and users based on semantic similarity between the user input and indexed user utterances in the vector database. The device may retrieve a set of relevant example conversations from the vector database based on the searching. The device may adapt a response style of a response to the user input based on the set of relevant example conversations and using an LLM. The device may output the response.

In some implementations, the device may store a set of example conversations between experts and users in a vector database. The device may index each user utterance in the vector database based on semantic similarity to expert responses. The device may retrieve a set of relevant example conversations from the vector database based on semantic similarity between a user input in a conversational context and the indexed user utterances. The device may adapt a response style of a chatbot based on the set of relevant example conversations. The device may output, using an LLM of the chatbot, a response to the user input that follows the adapted response style.

In some implementations, the device may generate a response style of a chatbot for responses to user inputs to a chatbot. The device may receive a user input. The device may retrieve, from a vector database of example conversations associated with the chatbot, a set of relevant example conversations based on the user input and a conversational context of the user input. The device may adapt, via in-context few-shot learning, the response style of the chatbot based on the set of relevant example conversations. The device may output a response to the user input using an LLM, where the response follows the adapted response style.

FIG. 2 is a diagram of an example implementation 200 associated with generating responses to user input using a response style. Example implementation 200 includes a computer system (e.g., computer 102) that operates with a vector database (DB) to provide a chatbot. In some implementations, the chatbot may be directed to psychologic or therapeutic subject matter.

The vector database may store example conversations between an expert (e.g., psychologist) and a user (e.g., patient). The vector database (e.g., persistent storage 120, remote database 138) may be a specialized database designed to store and manage conversational data in a format that enables efficient search, retrieval, and analysis. The vector database may include a collection of conversation records, each record representing a single conversation between an expert and a user. Each example conversation may include user utterances (sentences or questions from the user) and expert utterances (sentences or questions from the expert) in a conversational context (e.g., about a mental health issue, about a medical topic). The conversational record may be composed of multiple turns, where a turn represents a single exchange (e.g., question-response) between the expert and the user. Each turn in the conversation may be represented as a dense vector, which is a numerical representation of the text data. These vectors are generated using techniques such as word embeddings (e.g., Word2Vec embedding, GloVe embedding) or sentence embeddings (e.g., BERT embedding, Sentence-BERT embedding). The vector representations capture the semantic meaning of the text data, allowing for efficient search and comparison of similar conversations.

The vector database is indexed using a combination of traditional indexing techniques (e.g., keyword indexing) and vector-based indexing methods (e.g., annoy, faiss). This enables fast and efficient retrieval of conversations that are semantically similar to a user input or query.

Each conversation record in the database may include fields such as conversation identifier (ID) (a unique identifier for the conversation), expert ID (identifier for an expert (e.g., psychologist) involved in the conversation), and turns. The turns field(s) may include a list of turns in the conversation, where each turn includes text, a vector representation, and metadata about the conversation, such as timestamps, conversation topic, or relevant keywords.

Example implementation 200 shows a flowchart for a process of providing chatbot responses for user input, received by the computer system at 202. At 204, the computer system may set up a retrieve, augment, generate (RAG) framework that uses episodic memory to store and retrieve example conversations between experts and users. The RAG framework is a framework used in AI LLMs to generate human-like text based on a given prompt or input. The RAG framework may be designed to improve the performance of LLMs by leveraging external knowledge sources, such as the vector database of example conversations. The vector database provides the chatbot with access to a larger context window and thus provides more accurate responses.

At 206, the computer system may search the vector database. For example, the episodic memory may be used to recall specific events or experiences from the past, allowing the chatbot to learn from the experiences and adapt to new situations. This step involves searching and retrieving relevant information such as a set of relevant example conversations. The goal is to find relevant examples of conversations that match the context and semantics of the prompt of the user input. An example conversation may be relevant to the user input if the example conversation (indexed user utterances in the vector database) between an expert and a user is semantically similar to the user input.

At 208, the computer system may retrieve the set of relevant example conversations. The retrieved set of relevant example conversations may be used to augment the input prompt, providing additional context and knowledge that can be used to generate a more informed and relevant response. The computer system may use the augmented input to generate the response using an LLM that has additional context and knowledge to produce a more accurate and coherent response.

Additionally, or alternatively, at 210, the computer system may perform few-shot learning to generate a response that better follows a response style. “In-context learning” refers to the fact that the model learns the response style within the context of the conversation, rather than relying on external knowledge or pre-training. Few-shot learning is a machine learning technique that can be used to train an LLM to develop a response style for a specific context, using only a few examples (e.g., 1-10). The goal is to enable the LLM to learn the response style from a minimal number of examples and then generalize the response style to new, unseen inputs.

For in-context few-shot learning, the computer system may use a teaching-by-example approach, where the chatbot is trained on example conversations between experts and users. For example, the computer system may use the set of relevant example conversations to fine-tune the chatbot's response generation model, allowing the chatbot to learn from the examples, adapt to new situations, and provide the response with a response style that matches the user utterances of the user input. “Response style” refers to the tone, language, and structure of the response, which is adapted to match the conversational context and user input.

In order for the few-shot learning of the response style to be successful, the computer system is to construct the examples correctly. The computer system may construct examples by indexing conversations between experts and users for multiple topics and multiple communication styles, and storing the conversations in the vector database. The chatbot may then retrieve the examples and use them to generate responses to user input. The quality of the examples may directly impact the performance of the chatbot.

At 212, the computer system may generate the response using an LLM for the chatbot. The response may follow the response style for the user input. At 214, the computer system may output the response via the chatbot. Once the response style has been generated using in-context few-shot learning, the chatbot outputs the response that follows the learned response style. The generation of the output may involve several steps. For example, the chatbot may generate a response to the user input, using the learned response style and the context of the conversation. The chatbot may post-process the response to ensure that it meets the desired criteria, such as grammar, syntax, and tone. The response may be formatted according to the required output format, such as text, speech, or a combination of both. The response is then delivered to the user through the chatbot interface (e.g., messaging app, website, or voice assistant).

To ensure that the chatbot follows the response style, the computer system may evaluate the output response against a learned response style. This evaluation may involve checking the response for tone (e.g., formal, informal, empathetic, or enthusiastic), language (e.g., formal, informal, technical, or colloquial), structure (e.g., a simple answer, a detailed explanation, or a conversational dialogue) and content (e.g., providing information, answering a question, or making a recommendation).

The computer system may use several techniques to ensure that the chatbot follows the response style, including response templates, language models, grammar-based generation, spell-checking, grammar-checking, fluency evaluation, or feedback mechanisms. Providing the response with the learned response style may improve the user experience by providing a clear and predictable interaction with the chatbot. A response style that matches the user's preferences and expectations can increase engagement and encourage the user to continue interacting with the chatbot. A matching response style that is professional and consistent enhances the credibility of the chatbot and the organization that the chatbot represents. A response style that is tailored to the user's needs and preferences leads to better outcomes, such as increased sales, improved customer satisfaction, or more effective problem-solving. Better and more efficient responses lead to less wasted time with the chatbot, which conserves power and processing resources.

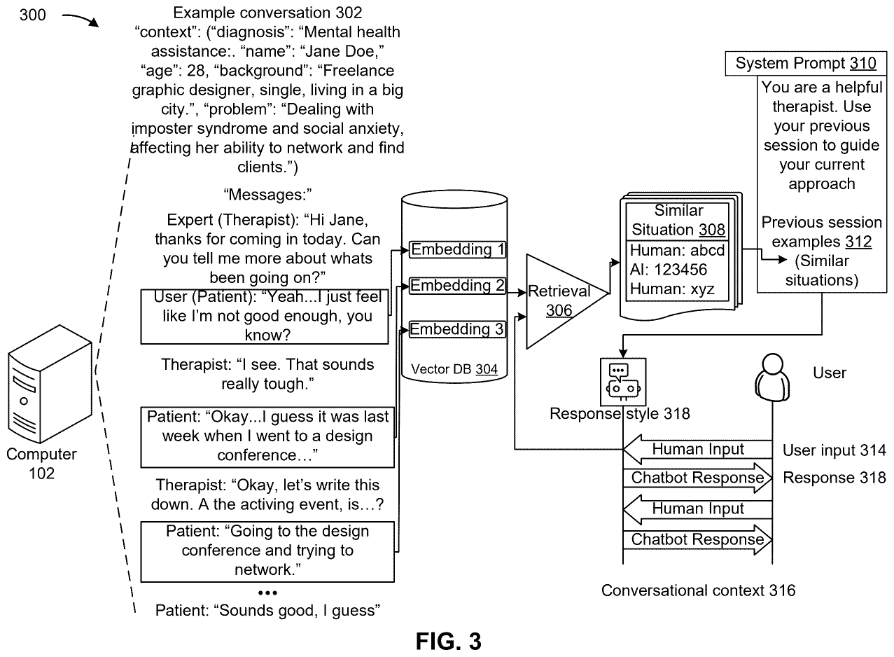

FIG. 3 is a diagram of an example implementation 300 associated with using a response style for a response to user input. Example implementation 300 includes a vector database 304 that stores conversations, including example conversation 302. Each turn (expert question, user response) of the example conversation 302 has a vector representation that is embedded in the vector database 304 (e.g., embedding 1, embedding 2, embedding 3). The vector database may be a Milvus database or Redis database and may store a set of example conversations between experts and users, indexed based on semantic similarity to expert responses.

As part of the retrieval at 306, a computer system (e.g., computer 102) may search the vector database 304 for relevant example conversations based on semantic similarity between user input 314 in a conversational context 316 and the indexed user utterances. For example, the search function may retrieve the embedded turns as a set of relevant example conversations from the vector database 304, based on a combination of the user input, the conversational context, and a set of predefined criteria. The set of predefined criteria may include a number of turns in a conversation or a presence of a set of specific keywords. The relevant example conversations may present a similar situation 308 as the user input 314. The relevant example conversations 312 from previous sessions may augment a system prompt 310 associated with the user input 314. The computer system may use a response generation function that adapts a response style 318 of a response from the chatbot or LLM based on the set of relevant example conversations. For example, the response generation function may use in-context few-shot learning to adapt the response style based on the set of relevant example conversations. The response style 318 of the chatbot or LLM may, for example, be based on a cognitive behavioral therapist style.

Additionally, or alternatively, the computer system may generate the conversational context 316 based on a set of predefined formulas associated with efficient retrieval of example conversations. For example, a conversational context generation function may use a set of predefined criteria, such as a number of turns in a conversation or a presence of a set of specific keywords, to generate the conversational context 316.

The computer system may use an episodic memory function that stores and retrieves specific examples from past conversations, similar to a therapist's ability to recall specific experiences from the therapist's past. For example, the episodic memory function may use a combination of natural language processing (NLP) and machine learning algorithms to identify and retrieve relevant examples. The computer system may use a semantic search function that searches for example conversations based on their underlying meaning, rather than just their literal text. For example, the semantic search function may use a combination of NLP and machine learning algorithms to identify the most relevant examples based on their semantic similarity.

Additionally, or alternatively, the computer system may include an in-context few-shot learning function that performs in-context few-shot learning at an inference stage of the conversation context. For example, the in-context few-shot learning function may provide the set of relevant example conversations to the LLM as a prompt, without modifying the LLM or using additional training data.

Additionally, or alternatively, the computer system may decouple the vector database and the LLM, where the vector database and the LLM are updated independently. For example, an update function may allow for the vector database to be updated without affecting the LLM, and vice versa.

While example implementation 300 illustrates the expert as a therapist, other implementations may involve other professionals, such as a financial advisor, a business consultant, and other types of expertise-driven conversational based services.

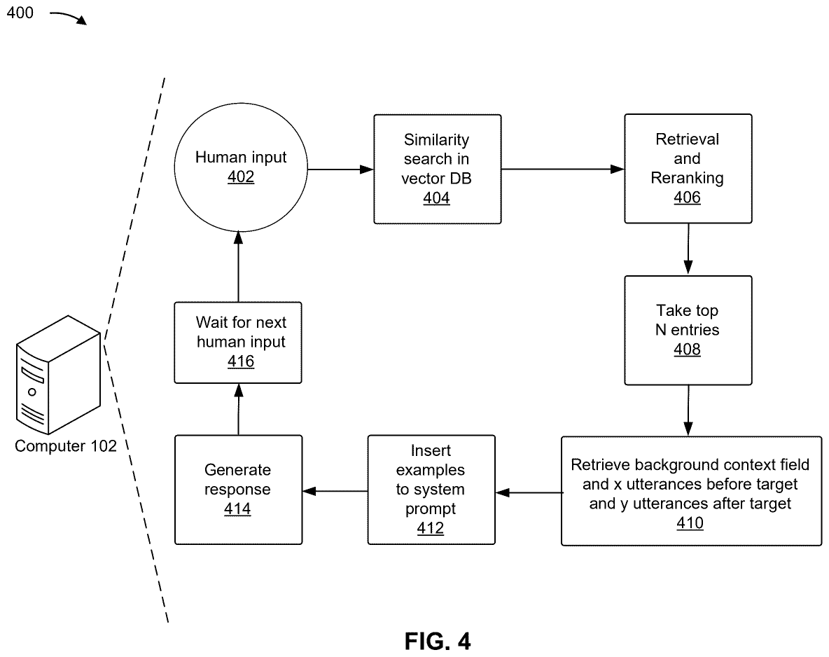

FIG. 4 is a diagram of an example implementation 400 associated with providing chatbot responses to user inputs using a response style.

At 402, human input is entered into an expertise chatbot, operated by a computer system (e.g., computer 102). At 404, the computer system may perform a similarity search in a vector database for conversations similar to the input. At 406, the computer system may retrieve a set of relevant example conversations based on the input and a conversational context.

Example conversations may be ranked or reranked in the vector database or in the results for relevance. At 408, the computer system may take the top N entries, ranked based on similarity, in order to adapt the response style of the chatbot. At 410, the computer system may retrieve a background context field, x utterances before a target turn or conversation, and y utterances after the target turn or conversation. The background context field may include a set of previous conversations or utterances that provide relevant information to understand the current conversation or user input. The x utterances before a target turn or conversation may include x previous conversations or utterances that occurred before the specific conversation or user input being processed (target turn). These previous conversations or utterances can provide context and help the system understand the topic, intent, or tone of the current conversation. Similarly, y utterances after the target turn or conversation may include y subsequent conversations or utterances that occur after the target turn. These subsequent conversations or utterances can provide additional context and help the system understand how the conversation evolved or how the user responded to previous interactions. The values of x and y can vary depending on the specific implementation, the conversational context, and the requirements of the conversational system. The goal is to retrieve a sufficient amount of context to provide accurate and relevant responses to the user's input.

At 412, the computer system may insert the background context field and the utterances into a system prompt associated with the input, to generate a response to the input that follows a response style similar to the relevant example conversations. Chatbot responses may then be tailored to a specific conversational context, such as a psychotherapy context. For example, the response style may involve using language and a tone that are similar to those used by a cognitive behavioral therapist.

The process may be repeated with further iterations, waiting for the next human input at 416. The iterations of inputs, retrieved example conversations, and corresponding responses may help to fine-tune or adjust the parameters of an LLM of the chatbot, to improve its performance on a specific task or domain. Iterative adaptation may involve adjusting the response style based on user feedback or changes in the conversational context. In some implementations, new example conversations may be added to the vector database without modifying the LLM. By adapting the response to a response style of the user, the computer system may help the user to have a better experience and processing resource would not be wasted.

FIG. 5 is a flowchart of an example process 500 associated with adaptation of a language model response style. One or more process blocks of FIG. 5 are performed by a computer system (e.g., computer 102) and/or by another device or a group of devices separate from or including the computer system.

As shown in FIG. 5, process 500 includes receiving user input in a conversational context (block 510). For example, the computer system may receive user input in a conversational context, as described above.

As further shown in FIG. 5, process 500 includes searching a vector database for relevant example conversations between experts and users based on semantic similarity between the user input and indexed user utterances in the vector database (block 520). For example, the computer system may search a vector database for relevant example conversations between experts and users based on semantic similarity between the user input and indexed user utterances in the vector database, as described above.

As further shown in FIG. 5, process 500 includes retrieving a set of relevant example conversations from the vector database based on the searching (block 530). For example, the computer system may retrieve a set of relevant example conversations from the vector database based on the searching, as described above.

As further shown in FIG. 5, process 500 includes adapting a response style of a response to the user input based on the set of relevant example conversations and using an LLM (block 540). For example, the computer system may adapt a response style of a response to the user input based on the set of relevant example conversations and using an LLM, as described above.

As further shown in FIG. 5, process 500 includes outputting the response (block 550). For example, the computer system may output the response, as described above.

Process 500 may include additional aspects, such as any single aspect or any combination of aspects described below and/or in connection with one or more other processes described elsewhere herein.

In a first aspect, the set of relevant example conversations are associated with a domain or task involving a professional service, such as psychotherapy, medical consulting, financial consulting, legal consulting, or business consulting.

In a second aspect, alone or in combination with the first aspect, the vector database is a Milvus database or Redis database.

In a third aspect, alone or in combination with one or more of the first and second aspects, process 500 includes fine-tuning the LLM independently of updating the vector database.

In a fourth aspect, alone or in combination with one or more of the first through third aspects, process 500 includes performing in-context few-shot learning at an inference stage of the conversation context.

In a fifth aspect, alone or in combination with one or more of the first through fourth aspects, the retrieving of the set of relevant example conversations comprises retrieving the set of relevant example conversations based on a combination of the user input, the conversational context, and a set of predefined criteria.

In a sixth aspect, alone or in combination with one or more of the first through fifth aspects, the set of predefined criteria comprises a number of turns in a conversation or a presence of a set of specific keywords.

In a seventh aspect, alone or in combination with one or more of the first through sixth aspects, process 500 includes generating the conversational context based on a set of predefined formulas associated with efficient retrieval of example conversations.

In an eighth aspect, alone or in combination with one or more of the first through seventh aspects, the adapted response style is associated with a cognitive behavioral therapist.

In a ninth aspect, alone or in combination with one or more of the first through eighth aspects, process 500 includes performing in-context few-shot learning of the LLM by providing the set of relevant example conversations to the LLM as a prompt, without modifying the LLM or using additional training data.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

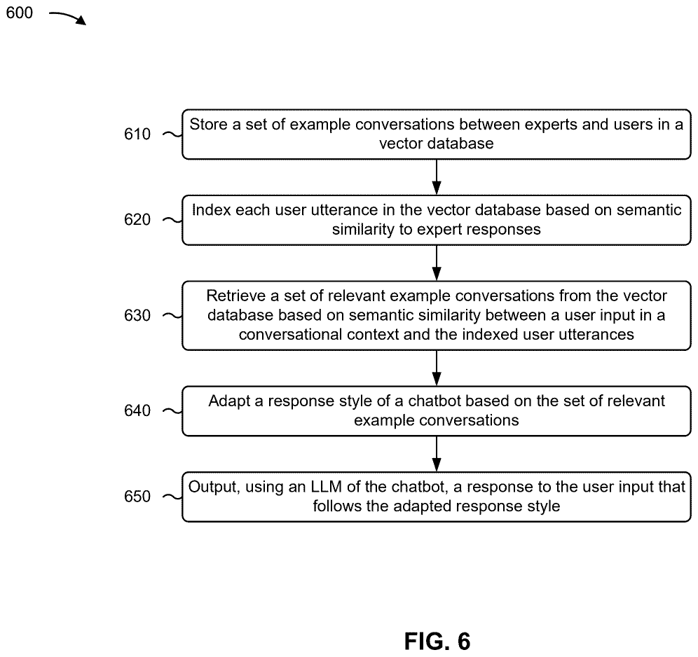

FIG. 6 is a flowchart of an example process 600 associated with adaptation of a language model response style. One or more process blocks of FIG. 6 are performed by a computer system (e.g., computer 102) and/or by another device or a group of devices separate from or including the computer system.

As shown in FIG. 6, process 600 includes storing a set of example conversations between experts and users in a vector database (block 610). For example, the computer system may store a set of example conversations between experts and users in a vector database, as described above.

As further shown in FIG. 6, process 600 includes indexing each user utterance in the vector database based on semantic similarity to expert responses (block 620). For example, the computer system may index each user utterance in the vector database based on semantic similarity to expert responses, as described above.

As further shown in FIG. 6, process 600 includes retrieving a set of relevant example conversations from the vector database based on semantic similarity between a user input in a conversational context and the indexed user utterances (block 630). For example, the computer system may retrieve a set of relevant example conversations from the vector database based on semantic similarity between a user input in a conversational context and the indexed user utterances, as described above.

As further shown in FIG. 6, process 600 includes adapting a response style of a chatbot based on the set of relevant example conversations (block 640). For example, the computer system may adapt a response style of a chatbot based on the set of relevant example conversations, as described above.

As further shown in FIG. 6, process 600 includes outputting, using an LLM of the chatbot, a response to the user input that follows the adapted response style (block 650). For example, the computer system may output, using an LLM of the chatbot, a response to the user input that follows the adapted response style, as described above.

Process 600 may include additional aspects, such as any single aspect or any combination of aspects described below and/or in connection with one or more other processes described elsewhere herein.

In a first aspect, the LLM capable of in-context learning.

In a second aspect, alone or in combination with the first aspect, the retrieving of the set of relevant example conversations comprises retrieving the set of relevant example conversations based on a combination of the user input, the conversational context, and a set of predefined criteria.

In a third aspect, alone or in combination with one or more of the first and second aspects, the adapting of the response style comprises adapting the response style using few-shot learning with the set of relevant example conversations.

In a fourth aspect, alone or in combination with one or more of the first through third aspects, the operations further comprise decoupling the vector database and the LLM, wherein the vector database and the LLM are updated independently of each other. This may include decoupling conversation protocols from the LLM.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

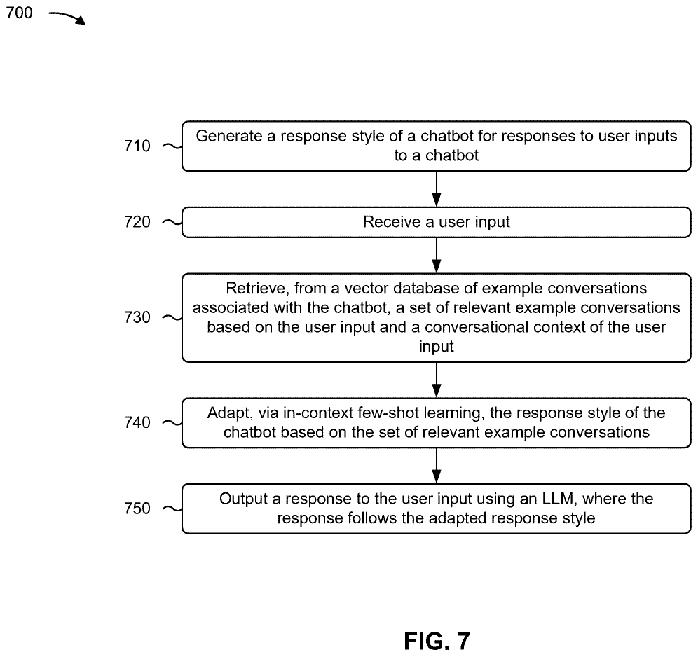

FIG. 7 is a flowchart of an example process 700 associated with adaptation of a language model response style. One or more process blocks of FIG. 7 are performed by a computer system (e.g., computer 102) and/or by another device or a group of devices separate from or including the computer system.

As shown in FIG. 7, process 700 includes generating a response style of a chatbot for responses to user inputs to a chatbot (block 710). For example, the computer system may generate a response style of a chatbot for responses to user inputs to a chatbot, as described above.

As further shown in FIG. 7, process 700 includes receiving a user input (block 720). For example, the computer system may receive a user input, as described above.

As further shown in FIG. 7, process 700 includes retrieving, from a vector database of example conversations associated with the chatbot, a set of relevant example conversations based on the user input and a conversational context of the user input (block 730). For example, the computer system may retrieve, from a vector database of example conversations associated with the chatbot, a set of relevant example conversations based on the user input and a conversational context of the user input, as described above.

As further shown in FIG. 7, process 700 includes adapting, via in-context few-shot learning, the response style of the chatbot based on the set of relevant example conversations (block 740). For example, the computer system may adapt, via in-context few-shot learning, the response style of the chatbot based on the set of relevant example conversations, as described above.

As further shown in FIG. 7, process 700 includes outputting a response to the user input using an LLM, where the response follows the adapted response style (block 750). For example, the computer system may output a response to the user input using an LLM, where the response follows the adapted response style, as described above.

Process 700 may include additional aspects, such as any single aspect or any combination of aspects described below and/or in connection with one or more other processes described elsewhere herein.

In a first aspect, the operations further comprise performing the in-context few-shot learning at an inference stage, without additional training or fine-tuning of the LLM.

In a second aspect, alone or in combination with the first aspect, the operations further comprise updating the vector database independently of the LLM.

In a third aspect, alone or in combination with one or more of the first and second aspects, the operations further comprise using the in-context few-shot learning to decouple conversation skills of the vector database from the LLM.

In a fourth aspect, alone or in combination with one or more of the first through third aspects, the operations further comprise further adapting the response style iteratively based on subsequent user inputs, user behavior, and the conversational context.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method comprising:
receiving user input in a conversational context;
searching a vector database for relevant example conversations between experts and users based on semantic similarity between the user input and indexed user utterances in the vector database;
retrieving a set of relevant example conversations from the vector database based on the searching;
constructing a system prompt associated with the user input by inserting the set of relevant example conversations into the system prompt as few-shot examples that teach a large language model (LLM) a response style;
adapting the response style for a response to the user input at an inference stage by performing in-context few-shot learning with the LLM using the system prompt to obtain an adapted response style, without modifying parameters of the LLM during performance of the in-context few-shot learning and without using additional training data for the in-context few-shot learning;
generating, using the LLM, the response to the user input, wherein the response follows the adapted response style; and
outputting the response.

2. The method of claim 1, wherein the set of relevant example conversations is associated with a domain or task involving psychotherapy, medical consulting, financial consulting, legal consulting, or business consulting.

3. The method of claim 1, wherein the vector database is a MIL VUS database or a REDIS database.

4. The method of claim 1, further comprising fine-tuning the LLM independently of updating the vector database.

5. The method of claim 1, wherein the set of relevant example conversations comprises example conversations from previous sessions.

6. The method of claim 1, wherein the set of relevant example conversations is retrieved based on a combination of the user input, the conversational context, and a set of predefined criteria.

7. The method of claim 6, wherein the set of predefined criteria comprises a number of turns in a conversation or a presence of a set of specific keywords.

8. The method of claim 1, further comprising generating the conversational context based on a set of predefined formulas associated with efficient retrieval of example conversations.

9. The method of claim 1, wherein the adapted response style is associated with a cognitive behavioral therapist.

10. The method of claim 1, further comprising retrieving, for a target turn or conversation of at least one example conversation in the set of relevant example conversations, a background context field including a number x of utterances before the target turn or conversation and a number y of utterances after the target turn or conversation, wherein constructing the system prompt further comprises inserting the background context field into the system prompt.

11. A computer system comprising:
a processor set;
one or more computer-readable storage media; and
program instructions stored on the one or more computer-readable storage media to cause the processor set to perform operations comprising:
storing a set of example conversations between experts and users in a vector database;
indexing each user utterance as an indexed user utterance in the vector database based on semantic similarity to expert responses;
retrieving a set of relevant example conversations from the vector database based on semantic similarity between a user input in a conversational context and the indexed user utterances;
constructing a system prompt associated with the user input by inserting the set of relevant example conversations into the system prompt as few-shot examples that teach a large language model (LLM) of a chatbot a response style;
adapting the response style of the chatbot for a response to the user input at an inference stage by performing in-context few-shot learning with the LLM using the system prompt to obtain an adapted response style, without modifying parameters of the LLM during performance of the in-context few-shot learning and without using additional training data for the in-context few-shot learning;
generating, using the LLM of the chatbot, the response to the user input, wherein the response follows the adapted response style; and
outputting the response.

12. The computer system of claim 11, wherein the set of relevant example conversations comprises example conversations from previous sessions.

13. The computer system of claim 11, wherein the set of relevant example conversations is retrieved based on a combination of the user input, the conversational context, and a set of predefined criteria.

14. The computer system of claim 11, wherein the operations further comprise retrieving, for a target turn or conversation of at least one example conversation in the set of relevant example conversations, a background context field including a number x of utterances before the target turn or conversation and a number y of utterances after the target turn or conversation, wherein constructing the system prompt further comprises inserting the background context field into the system prompt.

15. The computer system of claim 11, wherein the operations further comprise:
decoupling the vector database and the LLM, wherein the vector database and the LLM are updated independently of each other and conversation protocols are decoupled from the LLM.

16. A computer program product comprising:
one or more computer-readable storage media;
program instructions stored on the one or more computer-readable storage media to cause a processor to perform operations comprising:
receiving user input in a conversational context;
searching a vector database for relevant example conversations between experts and users based on semantic similarity between the user input and indexed user utterances in the vector database;
retrieving a set of relevant example conversations from the vector database based on the searching;
constructing a system prompt associated with the user input by inserting the set of relevant example conversations into the system prompt as few-shot examples that teach a large language model (LLM) of a chatbot a response style;
adapting the response style of the chatbot for a response to the user input at an inference stage by performing in-context few-shot learning with the LLM using the system prompt to obtain an adapted response style, without modifying parameters of the LLM during performance of the in-context few-shot learning and without using additional training data for the in-context few-shot learning;
generating, using the LLM of the chatbot, the response to the user input, wherein the response follows the adapted response style; and
outputting the response.

17. The computer program product of claim 16, wherein the set of relevant example conversations comprises example conversations from previous sessions.

18. The computer program product of claim 16, wherein the operations further comprise:
updating the vector database independently of the LLM.

19. The computer program product of claim 16, wherein the operations further comprise:
retrieving the set of relevant example conversations based on a combination of the user input, the conversational context, and a set of predefined criteria.

20. The computer program product of claim 16, wherein the operations further comprise:
retrieving, for a target turn or conversation of at least one example conversation in the set of relevant example conversations, a background context field including a number x of utterances before the target turn or conversation and a number y of utterances after the target turn or conversation, wherein constructing the system prompt further comprises inserting the background context field into the system prompt.
